(19) United States
(12) Patent Application Publication
(10) Pub. No.: US 2026/0284770 A1
(43) Pub. Date: Sep. 24, 2026

(54) MULTIPLE ARC JOINING METHOD

(71) Applicant: Fronius International GmbH, Pettenbach (AT)

(72) Inventor: Dominik SÖLLINGER, Pettenbach (AT)

(73) Assignee: Fronius International GmbH, Pettenbach (AT)

(21) Appl. No.: 19/476,362

(22) PCT Filed: Apr. 16, 2024
(86) PCT No.: PCT/EP2024/060284

§ 371 Date: Oct. 17, 2025

(30) Foreign Application Priority Data
Apr. 18, 2023 (EP) 23168435.8

(51) Int. Cl. B23K 9/133; B23K 9/09; B23K 9/173

(52) U.S. Cl. CPC B23K 9/133; B23K 9/09; B23K 9/1735

(57) ABSTRACT

To enable the production of fish scale seam patterns in a multiple arc joining method, in each arc joining process at least one joining parameter, which influences a deposition rate of the arc joining process dependent on the wire feed speed and the joining wire, is varied by a periodic variation function with a variation frequency, so that as a result of this variation, in each arc joining process, the predetermined time curve of the wire feed speed and the predetermined time curve of the joining current are periodically varied according to the variation function.

The present invention relates to a multiple arc joining method, with which a plurality of arc joining processes are carried out simultaneously in order to produce a joining seam on a workpiece, wherein, during the execution of the multiple arc joining method for implementing each of the arc joining processes involved, an arc burns at least temporarily between a joining electrode and the workpiece and at least temporarily an electrical joining current flows via the joining electrode and a joining wire is moved towards the arc at a wire feed speed, wherein each of the arc joining processes involved is carried out with a predetermined time curve of joining parameters and the time curve of the joining parameters comprises at least a predetermined time curve of the joining current and a predetermined time curve of the wire feed speed, which are dependent on one another. The invention also relates to an associated joining arrangement for implementing such a multiple arc joining method.

Welding methods can be differentiated between welding methods with consumable electrodes and welding methods with non-consumable electrodes. Examples of welding methods with consumable electrodes are the gas metal arc welding method (GMAW), and of welding methods with non-consumable electrodes the tungsten inert gas welding method (TIG). In a welding method with a non-consumable electrode, a welding wire is usually used as a filler material during welding, being fed into the arc and melting in the arc. In a welding method with a consumable electrode, the welding wire simultaneously also forms the electrode, although an additional welding wire could also be fed into the arc.

Gas metal arc welding methods (GMAW), which include e.g. the metal inert gas method (MIG) or the metal active gas process (MAG), have been known in the prior art for many years. In GMAW welding, a consumable electrode made of a metal electrode material is surrounded by a so-called shielding gas to protect the weld from the harmful influence of the ambient air.

In general, in arc welding, an arc is ignited between the electrode and the workpiece to be welded, using an electrical welding voltage or a resulting electrical welding current. In a consumable electrode welding method, the arc melts the electrode and the region of the workpiece surrounding the electrode, thereby creating a material bond. The same or a similar material as for the workpiece is usually used as the electrode material. The electrode is fed to the weld at a specific feed rate; the feed rate can be fixed, e.g. in manual welding by hand or by a setting on the welding tool, or can also be dependent on other parameters, for example on the welding method implemented, on a welding speed at which the electrode is moved relative to the parent material, or depending on the welding current, etc.

Various welding processes are also well-known in arc welding. A welding process is essentially the control of the time curve of the welding voltage and/or of the welding current. Examples of a well-known welding process are a pulsed welding process or an interval welding process or a spray arc welding process. In the pulsed welding process, a base voltage is regularly superimposed with an increased welding voltage, whereby a base current and a pulsed current alternate at a predetermined frequency and pulse time. With a pulsed welding process, the heat input into the workpiece can be reduced, which is very advantageous in many applications. In the interval welding process, welding phases and pause phases alternate cyclically, a welding cycle consisting of a welding phase and a pause phase. The transition between a welding phase and a pause phase is characterized by the detachment of a molten droplet from the electrode. This is often preceded by a short circuit when the electrode comes into contact with the molten bath. The welding current can have a desired time curve during the welding phase or also during the pause phase, for example a pulse-like welding current during the welding phase. An example of such an interval welding process is the well-known cold metal transfer (CMT) welding method, in which the wire feed of the electrode is also dynamically changed during welding. The heat input into the workpiece can also be reduced using an interval welding process, which is very advantageous in many applications. There are also a number of other welding methods. In a spray arc welding process, welding is usually carried out with a constant welding current and without short-circuit interruption. The spray arc generates a high heat input into the workpiece, a high deposition rate and a deep penetration.

In addition to welding, arc soldering is also known as a joining method. Arc soldering differs from arc welding in that the workpiece to be welded is melted during welding, whereas in arc soldering not. In arc soldering, only the solder is melted. An arc soldering method can be carried out using the same equipment as arc welding. In arc soldering, a distinction can also be made between soldering methods with a consumable electrode, which is used as solder, and soldering processes with a non-consumable electrode. GMAW soldering and TIG soldering are also known. The soldering processes can also be carried out analogously to the arc welding methods, for example as interval soldering methods, pulsed soldering methods or spray arc soldering methods.

The difference from welding is that soldering uses lower soldering currents and/or lower soldering voltages because the workpiece should not be melted during soldering.

For this reason, in the following only general reference will be made to arc joining or an arc joining method, whereby, within the meaning of the invention, this is understood to mean arc welding or an arc welding method or arc soldering or an arc soldering method. Likewise, a joining current is to be understood as a welding current or soldering current that flows through the electrode by applying a joining voltage (welding voltage or soldering voltage) to the electrode.

The joining method is carried out using a joining device, which is usually designed as a conventional welding device. The joining device comprises a power source for generating the joining voltage and the joining current and an electrode holder, for example a welding torch, in which the joining electrode is guided or held. The joining device further comprises a wire feed for moving the joining wire, which simultaneously forms the joining electrode in a joining method with a consumable electrode.

The invention relates in particular to an arc joining method in which, for joining purposes, an arc burns at least temporarily between an electrode and the workpiece to be joined, and a joining wire is melted in the process.

In order to increase the joining capacity, multiple arc joining methods have also become known, in which at least two arc joining processes are used simultaneously. These include, for example, what is known as the tandem pulsed welding method in which two pulsed arc welding processes are carried out simultaneously. In this case, for joining, at least two joining electrodes in the form of welding wires or soldering wires melt in an arc. As a rule, a separate joining device is used here for each pulsed arc joining process. With each joining device, a pulsed arc joining process is realized in that the respective control unit of the joining device controls or regulates the joining parameters accordingly, i.e. in particular the joining current, the joining voltage, the wire feed speed and optionally also the amount of shielding gas. In order to prevent any negative mutual influence of the simultaneously running pulsed arc welding processes—which may reduce the welding quality—it is also known for the two pulsed arc welding processes to be temporally synchronized. Examples of multiple welding methods with synchronized welding processes can be found in WO2020/8187 A1 or WO2022/129122 A1.

When joining using arc welding or arc soldering, a specific seam pattern of the joining seam is often desired. In principle, a distinction can be made between a continuous seam pattern and a fish scale seam pattern. The continuous seam pattern results in an essentially flat surface of the joining seam. In a fish scale seam pattern, however, scales are clearly visible on the surface, which form along the joining seam in the form of crescent-shaped beads. With a fish scale seam pattern, in particular the outgassing of hydrogen, oxygen and other gases from the joining seam during joining can be supported, which contributes to a reduction in the formation of pores in the joining seam. During welding, the mixing of the different temperature zones in the molten bath is also increased, which increases the weld continuity and thus the welding quality. A fish scale seam pattern is desired, for example, when welding aluminum but also when welding CrNi steels.

In a single-arc joining method, in which joining is carried out with only one joining electrode and one arc joining process, a fish scale joining seam can be realized in a known manner by cyclically changing the deposition rate of the implemented joining process at a constant frequency. The cyclical change in the deposition rate results in a fish scale joining seam. One of the major disadvantages here, however, is that due to the cyclical reduction of the deposition rate, the joining speed and also the average deposition rate are lower than with joining seams that have a continuous seam pattern. In the case of a fish scale joining seam, the joining process can thus only be carried out more slowly. As a result, the cost-effectiveness of such joining seams is often not always ensured.

In a multiple arc joining method, which can increase the joining performance itself, the deposition performance of a participating arc joining process cannot simply be changed cyclically, however, because this can negatively influence the participating arc joining processes. This can lead to unstable arc joining processes, joining defects, splashing of wire material on the base material, arc breaks, fusion defects, strong mutual arc deflections, etc. For this reason, it has not so far been possible to produce fish scale seam patterns using a multiple arc joining method.

It is therefore an object of the present invention to provide a multiple arc joining method and a joining arrangement for implementing a multiple arc joining method, which enable the production of fish scale seam patterns.

This object is achieved according to the invention in that in each arc joining process at least one joining parameter, which influences a deposition rate of the arc joining process dependent on the wire feed speed and the joining wire, is varied with a periodic variation function with a variation frequency, so that as a result of this variation, in each arc joining process the predetermined time curve of the wire feed speed and the predetermined time curve of the joining current are periodically varied depending on the variation function. In this case, the variation frequency is the same in every variation function. This means that the predetermined time curve of the wire feed speed and the predetermined time curve of the joining current are varied at the same frequency, the variation frequency. This allows the desired fish scale seam pattern to be produced using a multiple arc joining method without the negative influences mentioned above.

If each involved arc joining process is carried out with predetermined joining cycles repeated cyclically with a cycle frequency, the smallest cycle frequency of an involved arc joining process is selected to be 2 times to 50 times the variation frequency. This means that the variation of the joining parameters occurs considerably more slowly than the cycle frequencies of the arc joining processes, which has little impact on the execution of the arc joining process.

In particular in a multiple arc joining process with more than three arc joining processes carried out simultaneously, it is advantageous, if the variation functions of the arc joining processes are temporally synchronized with each other. This prevents the arc joining processes from negatively influencing each other due to the variations in the joining parameters. In the case of two arc joining processes, there is always a specific temporal relationship of the variation functions, and the synchronization prevents the temporal relationship from changing during the execution of the multiple arc joining process, which could negatively influence the joining process.

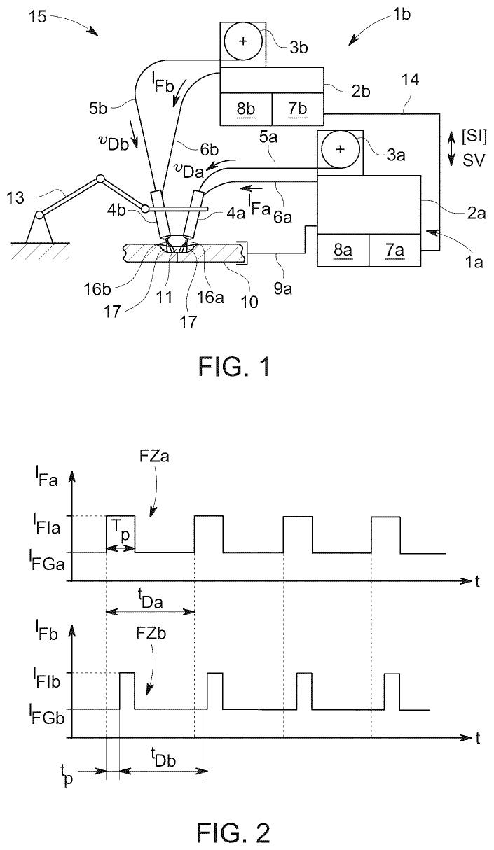

The present invention is described in greater detail below with reference to FIGS. 1 to 8, which, by way of example, show advantageous embodiments of the invention in a schematic and non-limiting manner. In the figures:

FIG. 1 shows a joining arrangement for implementing a multiple arc joining method,

FIG. 2 shows a multiple arc joining method with pulsed arc joining processes,

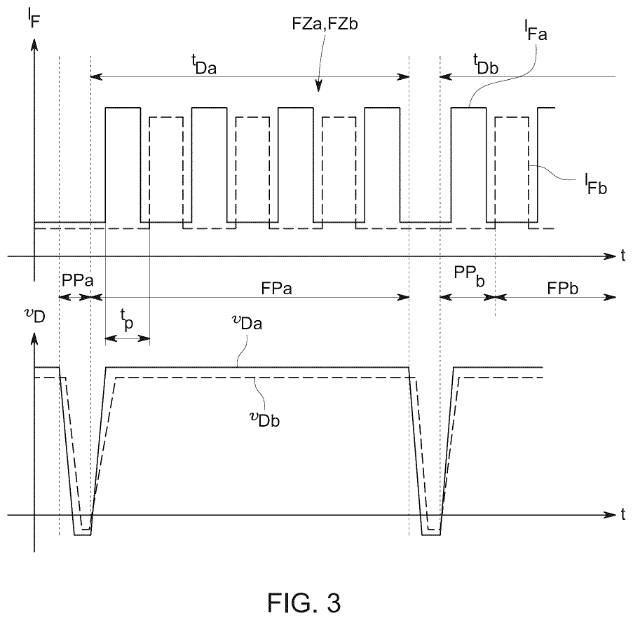

FIG. 3 shows a multiple arc joining method with interval arc joining processes,

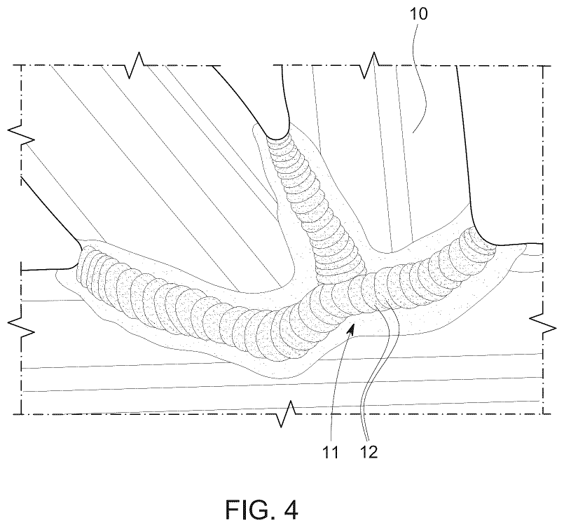

FIG. 4 shows a weld seam with a fish scale seam pattern,

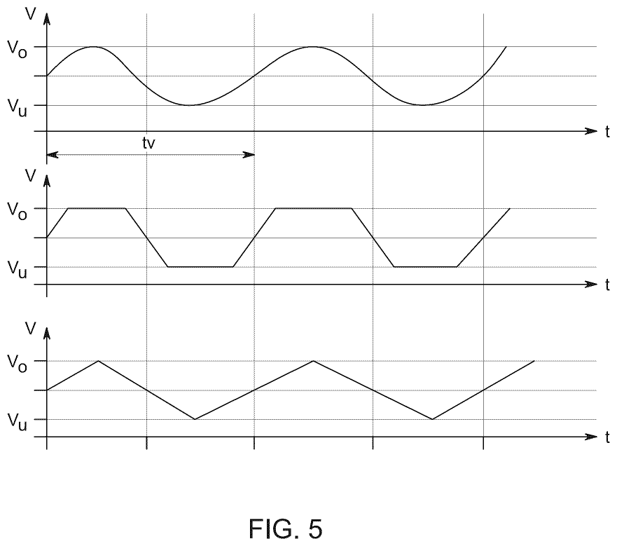

FIG. 5 shows examples of variation functions,

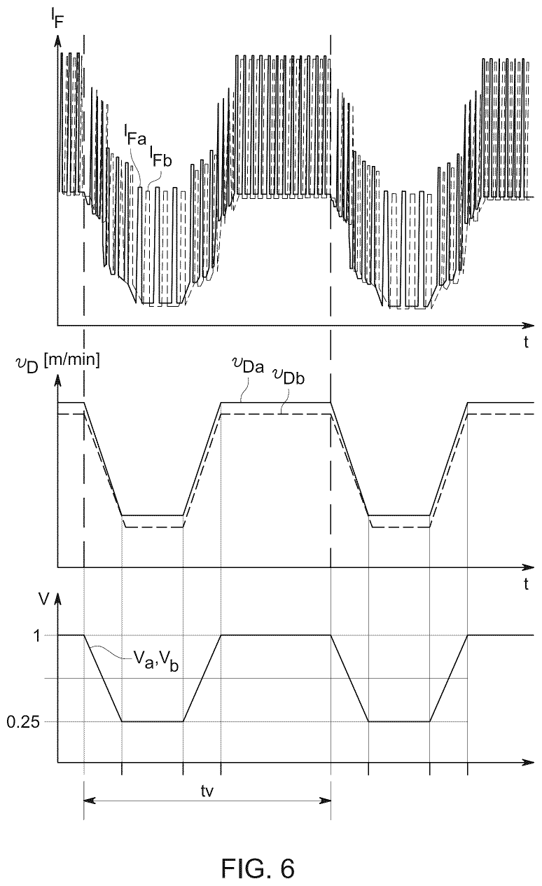

FIG. 6 shows a multiple arc joining method according to the invention with arc joining processes with a variation function with varied joining parameters,

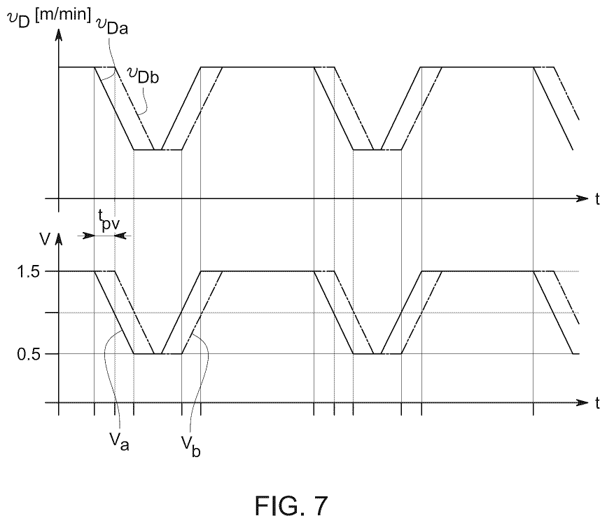

FIG. 7 shows an embodiment with time-shifted variation functions, and

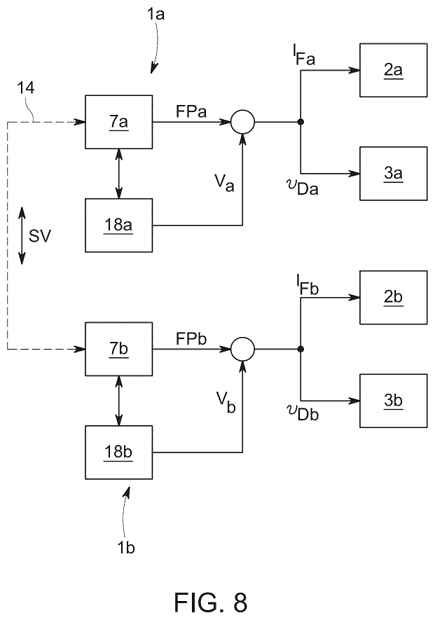

FIG. 8 shows an implementation of the multiple arc joining method according to the invention.

A possible joining arrangement 15 for a multiple arc joining method is shown schematically in FIG. 1. The joining arrangement 15 comprises two separate joining devices 1a, 1b, each provided with a power source 2a, 2b, a wire feed unit 3a, 3b and a joining electrode holder 4a, 4b (for example a welding torch in each case). Each of the power sources 2a, 2b provide the required joining voltage and the required joining current, which is applied in each case to the joining wire 5a, 5b as the consumable joining electrode 16a, 16b of the joining method. For this purpose, for example, a contact sleeve can be provided in a joining electrode holder 4a, 4b, to which contact sleeve the joining voltage is applied, e.g. via an electrical supply line 6a, 6b between the power source 2a, 2b and the contact sleeve, and which contact sleeve is electrically contacted by the joining wire 5a, 5b. However, a joining electrode holder 4a, 4b with a non-consumable joining electrode 16a, 16b (e.g. for implementing a TIG method) can also be used, to which the joining voltage is applied via the supply line 6a, 6b. In this case, the joining wire 5a, 5b is fed by the wire feed unit 3a, 3b into the arc 17 between the non-consumable joining electrode and the workpiece 10.

This means that during joining a certain joining current I_{Fa}, I_{Fb} flows at least temporarily over the respective joining electrode 16a, 16b, wherein for this purpose a ground line 9a, shown in FIG. 1 only for one joining device 1a, is provided between the power source 2a, 2b and that of the workpiece 10 to close the circuit.

The joining wire 5a, 5b is fed from the wire feed unit 3a, 3b, in each case, at a particular wire feed speed v_{Da}, v_{Db} in each joining device 1a, 1b. The wire feed unit 3a, 3b can be integrated in the joining device 1a, 1b in each case, but it can also be a separate unit or arranged at another location, for example in or on the joining electrode holder 4a, 4b.

The joining wire 5a, 5b and the electrical supply line 6a, 6b of a joining device 1a, 1b, and possibly also other lines between the power source 2a, 2b and the joining electrode holder 4a, 4b (for example a control line, a shielding gas line or a coolant line), may also be routed within a common tube assembly. The tube assembly may be, preferably releasably, coupled to the joining electrode holder 4a, 4b and to the power source 2a, 2b via suitable couplings.

A control unit 7a, 7b, which controls and monitors the joining process to be carried out, is also provided in a joining device 1a, 1b. For this purpose, measuring units (not shown) can also be provided, which record a joining parameter, such as a joining voltage or a joining current, and make it available to the control unit 7a, 7b. In order to implement the desired joining process, required joining parameters, such as a cycle frequency, the wire feed speed, the values of the joining currents, etc., are predetermined or adjustable in the control unit 7a, 7b. An input/output unit 8a, 8b may also be provided for inputting or displaying certain joining parameters or for displaying a joining status.

Typically, a control unit 7a, 7b in each joining device 1a, 1b also monitors the time curve of the joining current to implement an arc joining process with the respective joining device 1a, 1b. The time curve of the joining current is adjusted by controlling the joining voltage. However, this can also be the other way around, i.e. specification of the time curve of the joining voltage and controlling the joining current. For this control, an actual value of the control is usually required for each time step of the control, typically in the microsecond to millisecond range, i.e. for example an actual value of the joining voltage or of the joining current.

The control unit 7a, 7b is usually integrated in the joining device 1a, 1b and is designed as microprocessor-based hardware, on which software is executed that implements the required functions of the joining device 1a, 1b, for example the control of the joining current or of the joining voltage. However, the control unit 7a, 7b could also be designed as an external device of the joining device 1a, 1b. Likewise, the control unit 7a, 7b could also be implemented differently, for example as an integrated circuit (such as an application-specific integrated circuit (ASIC) or field programmable gate array (FPGA)) or in the form of an electrical or electronic circuit.

Such joining arrangements 15 and such joining devices 1a, 1b are of course well-known, and for this reason are not described in more detail here. For example, a conventional welding device can be used as the joining device 1a, 1b, with which not only a welding process but also a soldering process can be realized. For a multiple arc joining method comprising more than two joining processes, correspondingly more joining devices 1a, 1b are of course provided. A plurality of joining devices 1a, 1b of a multiple arc joining method may also be arranged in a common housing, possibly also with the associated wire feed units 3a, 3b.

To implement a multiple arc joining method, the two joining electrode holders 4a, 4b are arranged locally relative to one another in the exemplary embodiment shown, in such a way that they work in the same joining seam 11 on a workpiece 10. This arrangement of the joining electrode holders 4a, 4b relative to one another can be fixed, for example in that both joining electrode holders 4a, 4b are arranged on a welding robot 13 in a fixed spatial relationship to one another. The welding robot 13 then guides the two joining electrode holders 4a, 4b (as indicated in FIG. 1). The two joining electrode holders 4a, 4b can however also be guided manually. However, this arrangement of the joining electrode holders 4a, 4b relative to one another may also be variable, for example in that in each case one joining electrode holder 4a, 4b is guided by one welding robot 13. It is also irrelevant to the present invention whether the joining electrode holders 4a, 4b are arranged one after the other, next to one another or offset from one another in any other way in relation to the joining direction.

An arc joining method implements an arc joining process. An arc joining process is understood to be the time curve of the joining current and/or of the joining voltage, as well as the time curve of the wire feed speed. These time curves are predetermined for the implementation of the respective arc joining process, for example in the form of a joining program on a joining device 1a, 1b or by settings on a joining device 1a, 1b.

FIG. 2 shows, as a possible embodiment, a multiple arc joining method with arc joining processes, in which a pulsed arc joining process is implemented with the joining devices 1a, 1b. The pulsed arc joining processes are explained based on the curves of the joining currents I_{Fa}, I_{Fb} flowing through the joining electrodes 16a, 16b over time t. During the execution of the pulsed arc joining process by the joining devices 1a, 1b, an arc 17 naturally burns at least temporarily between the joining electrodes 16a, 16b and the workpiece 10.

In the time curve of the joining currents I_{Fa}, I_{Fb} of the pulsed arc joining processes, joining cycles FZa, FZb are provided, in which a base current I_{FG} and a comparatively increased pulse current I_{FI} alternate cyclically with a given cycle frequency f_{Da}, f_{Db}. Of course, the cycle frequency f_{Da}, f_{Db} is obtained as the reciprocal of the period t_{Da}, t_{Db} of a joining cycle FZa, FZb consisting of a base current phase with the base current I_{FG} and a pulse current phase with the pulse current I_{FI}. During the pulse current phase, a molten droplet of the joining wire 5a, 5b should advantageously be released into the joining seam 11. During the joining, the pulse frequency f_{Da}, f_{Db} and/or the value of the base current I_{FG} or of the pulse current I_{FI} of at least one of the joining processes can also change. The cycle frequency f_{D} of a pulsed arc joining process typically lies within the range of 5 Hz to 1 KHz.

It is of course also conceivable that the durations of a pulse current phase of a joining cycle FZ in the pulsed arc joining processes are not the same (as in FIG. 2) or that the values of the base current I_{FG} or of the pulse current I_{FI} are not the same. It is also conceivable that the cycle frequencies f_{Da}, f_{Db} are different in two pulsed arc joining processes.

The time curves of the joining currents I_{Fa}, I_{Fb} are of course shown in an idealized and simplified manner in FIG. 2. In real life, of course, there will be certain current ramps on the flanks. It is likewise often provided that the joining currents I_{Fa}, I_{Fb} drop in steps or with a different current curve during the transition from the pulse current I_{FI} to the base current I_{FG}, to promote droplet detachment. Short intermediate current pulses are also often provided in the base current phase to increase process stability. However, this does not change the period t_{D} of a joining cycle FZ and the resulting cycle frequency fp.

The wire feed speeds v_{Da}, v_{Db} of the pulsed arc joining processes involved in the multiple arc joining method according to FIG. 2, which are not shown in FIG. 2, can be predetermined, for example set at the joining devices 1a, 1b. The wire feed speeds v_{Da}, v_{Db} can be predetermined during implementation of the pulsed arc joining processes but also depending on the joining currents I_{Fa}, I_{Fb}.

FIG. 3 shows a multiple arc joining method, in which interval arc joining processes are implemented with the joining devices 1a, 1b. In an interval arc joining process, joining phases FPa, FPb and pause phases PPa, PPb alternate cyclically, a joining cycle FZa, FZb consisting in each case of a joining phase FPa, FPb and a pause phase PPa, PPb. This is shown in FIG. 3 using the time curves of the joining currents I_{Fa}, I_{Fb}, using the example of a multiple arc joining method with two interval arc joining processes. In the exemplary embodiment shown, a pulsed joining current I_{Fa}, I_{Fb} is provided, but this does not necessarily have to be the case. In a pause phase PPa, PPb, the current level of the joining currents I_{Fa}, I_{Fb} is reduced compared to the pulse currents in the joining phases FPa, FPb, to reduce the heat input into the workpiece 10, but the joining continues. However, in a pause phase PPa, PPb, a targeted short circuit may also occur temporarily between the joining electrode 16a, 16b and the workpiece 10. An interval arc joining process is also conceivable, in which the arc 17 is extinguished for a certain time in a joining cycle FZa, FZb, even several times.

The time curves of the joining currents I_{Fa}, I_{Fb} are of course again shown in an idealized and simplified manner in FIG. 3. In real life, of course, there will be certain current ramps on the flanks. The time curve of the joining currents I_{Fa}, I_{Fb} in the pause phases PPa, PPb and/or in the joining phases FPa, FPb can also be shown differently than is the case in FIG. 3.

FIG. 3 also shows the period t_{Da}, t_{Db} of a joining cycle FZa, FZb, from which the cycle frequencies f_{Da}, f_{Db} of the joining cycles FZa, Fzb also result. The cycle frequency f_{D} of an interval arc joining process typically lies within the range of 0.5 Hz to 100 Hz.

In FIG. 3, the wire feed speeds v_{Da}, v_{Db} are also shown for the joining cycles FZa, FZb. It can be seen that, in the exemplary embodiment shown, the wire feed is stopped in the pause phases PPa, PPb and the wire feed is even reversed for a short time. This time curve of the wire feed speeds v_{Da}, v_{Db} is also merely by way of example.

In addition to the arc joining processes described by way of example in FIG. 2 and FIG. 3, there can also be a number of other arc joining processes, also with cyclically repeating joining cycles FZ, with predefined time curves of a joining current I_{F}, a joining voltage or a wire feed speed v_{D}. An example of an arc joining process with cyclically repeating joining cycles FZ is a cold metal transfer (CMT) welding process. In this welding process, the welding wire (joining wire 5a, 5b) is moved towards the workpiece 10 until a short circuit is formed. The welding current (joining current I_{F}) is then interrupted, and the welding wire is moved back in the opposite direction. Due to the movement of the wire, the welding beads that form during a short circuit detach from the wire particularly easily. Only a few splashes occur. This procedure is repeated cyclically. During the welding phase, welding can also be carried out with a pulsed welding current. Another example is a spray arc joining process in which no joining cycles FZ are provided, but the joining current I_{F} and also the wire feed speed vₚ here being constant. A particularly high deposition rate can be achieved with a spray arc joining process. However, for the invention, arc joining processes with cyclically repeating joining cycles FZ are preferably used.

In a multiple arc joining method, the individual arc joining processes are usually temporally synchronized with each other, i.e. they have a specific temporal relationship to each other. This means that, for example, the joining cycles FZa, FZb are in a defined temporal relationship to each other. The temporal relationship is given as phase shift t_{D} (as in FIG. 2 and FIG. 3), which is usually between 0° and 180°. 0° usually refers to the case in which two current edges start at the same time, and 180° to the case in which two current edges start with a maximum distance apart.

Methods for synchronizing the arc joining processes are contained in the documents mentioned at the outset. For synchronization, a communication connection 14 (wired or wireless) can be provided between the joining devices 1a, 1b, via which synchronization information SI is exchanged as required.

In FIG. 4, a fish scale seam pattern of a joining seam 11 is shown taking the example of a weld seam on a welded workpiece 10. The crescent-shaped beads 12 which create the fish scale seam pattern can be seen along the joining seam 11. To produce such a fish scale seam pattern using a multiple arc joining method, the following procedure is followed according to the invention.

With the multiple joining method, a plurality of (at least two) arc joining processes are carried out simultaneously, to produce a joining seam 11 on a workpiece 10. In each arc joining process, a joining voltage is applied at least temporarily to a joining electrode 16a, 16b, which generates corresponding joining currents I_{Fa}, I_{Fb} via the joining electrode 16a, 16b. During the execution of the multiple joining method, an arc 17 burns at least temporarily between the joining electrodes 16a, 16b and the workpiece 10 in each of the arc joining processes involved, and an electrical joining current I_{Fa}, I_{Fb} flows at least temporarily via the respective joining electrode 16a, 16b. In addition, in this case, a joining wire 5a, 5b is moved towards the arc 17 with a wire feed speed v_{Da}, v_{Db}. Each arc joining process involved is carried out with a predetermined time curve of the joining current I_{Fa}, I_{Fb} and of the wire feed speed v_{Da}, v_{Db}. In each arc joining process involved, at least one joining parameter, which joining parameter influences a deposition rate A of the arc joining process, dependent on the wire feed speed v_{Da}, V Db and the joining wire 5a, 5b, is varied by a periodic variation function vₐ, v_{b} with a variation frequency fᵥ in such a way, that in each arc joining process the predetermined time curve of the wire feed speed v_{Da}, v_{Db} and the predetermined time curve of the joining current I_{Fa}, I_{Fb} depending on the variation function vₐ, v_{b} is varied periodically.

As a result of the periodic variation, the actual time curves of the joining current I_{Fa}, I_{Fb} predetermined by the implemented arc joining processes, and the wire feed speed v_{Da}, v_{Db}, are changed. This means that joining is performed at least sometimes with different joining parameters from those provided for by the arc joining processes.

According to the invention, the deposition rate of the arc joining processes involved in the multiple arc joining method is varied cyclically with a predetermined variation frequency fᵥ. Preferably, the wire feed speeds v_{Da}, v_{Db} and the joining currents I_{Fa}, I_{Fb} are cyclically lowered from the predetermined wire feed speeds v_{Da}, v_{Db} and joining currents I_{Fa}, I_{Fb} and increased again to the predetermined wire feed speeds v_{Da}, v_{Db} and joining currents I_{Fa}, I_{Fb}. The wire feed speeds v_{Da}, v_{Db} and the joining currents I_{Fa}, I_{Fb} therefore preferably vary between the values predetermined for the respective arc joining process performed and lower values. Instead of a lowering, however, increasing is also possible by the variation. It is also possible that the variation can result in lowering and in increasing.

However, the variation does not occur abruptly between these values, but rather smoothly according to the predefined periodic variation function V (fᵥ).

The periodic variation function V (fᵥ) is, for example, a sine or cosine function, a trapezoidal function or a triangular function, as shown by way of example in FIG. 5, or another periodic function with an amplitude curve running within a period ty over time. The period ty of the variation function V (fᵥ) gives the variation frequency fᵥ.

The amplitude of the periodic variation function V (fᵥ) preferably varies between an upper variation value vₒ and a lower variation value vᵤ. How the variation is realized does not matter.

For example, the variation function V can be normalized to one. The value one of the variation function V then corresponds to a superposition that results in the predetermined value of the wire feed speed v_{Da}, v_{Db} or of the joining current I_{Fa}, I_{Fb}. The lower variation value vᵤ is greater than zero, preferably within the range of 0.1 to 1. The upper variation value vₒ is preferably one, but can be selected from the range from one to 10. The variation function V can, however, also be specified in percent, where 100% corresponds to a superposition that results in the predetermined value of the wire feed speed v_{Da}, v_{Db} or of the joining current I_{Fa}, I_{Fb}. Likewise, the variation function V could directly correspond to values of the wire feed speed v_{Da}, v_{Db} or of the joining current I_{Fa}, I_{Fb}.

The variation frequency fᵥ is selected in a way that in the case of a multiple arc joining method with arc joining processes with joining cycles FZ, the lowest cycle frequency f_{D} of a joining cycle of an arc joining process of the multiple arc joining method is at least twice as high as the variation frequency fᵥ. Preferably, the lowest cycle frequency f_{D} of an arc joining process of the multiple arc joining method is 2 to 50 times the variation frequency fᵥ. In the case of a multiple arc joining method with arc joining processes without joining cycles, such as a spray arc process, the variation frequency fᵥ is preferably selected from between 0.1 Hz and 25 Hz. In principle, it can be said that the higher the variation frequency fᵥ is selected, the more finely scaled the joining seam 11 becomes, and vice versa.

For each arc joining process involved in the multiple arc joining method, such a variation function V(fV) results, all variation functions vₐ(fᵥ), v_{b}(fᵥ), however, having the same variation frequency fᵥ. The variation functions vₐ(fᵥ), v_{b}(fᵥ) do not necessarily have to be the same, as long as the variation frequency fᵥ is the same. The variation functions vₐ(fᵥ), v_{b}(fᵥ) of the arc joining processes involved are preferably also temporally synchronized with each other, i.e. they are in a predefined temporal relationship to each other. The phase shift t_{pV} (see for example FIG. 6) of the periodic variation functions vₐ(fᵥ), v_{b}(fᵥ) of the arc joining processes involved preferably lies within the range from 0° to a maximum of 180°, preferably a maximum of 30°. By synchronizing the variation functions vₐ(fᵥ), v_{b}(fᵥ) it can be ensured that the temporal reference of the variation functions vₐ(fᵥ), v_{b}(fᵥ) does not change but rather remains constant during the execution of the multiple arc joining method, which ensures better joining results.

The deposition rate A of an arc joining process with a joining wire 5a, 5b depends on the wire feed speed v_{Da}, v_{Db} and on the joining wire 5a, 5b and is defined, for example, as

$$A = \frac{{v}_{D} \cdot {G}_{F} \cdot 60}{1000} .$$

Here, v_{D} denotes the respective wire feed speed v_{Da}, v_{Db} in m/min and G_{F} denotes the specific joining wire weight of the joining wire 5a, 5b in g/m. Once the joining wire 5a, 5b used for the arc joining process is known, the specific joining wire weight will of course also be known.

This formula shows that the deposition rate A of an arc joining process can be influenced by the wire feed speed v_{Da}, v_{Db}. Since, in an arc joining process, the wire feed speed v_{Da}, v_{Db} and the joining current I_{Fa}, I_{Fb} are dependent on each other and this dependency is known or predetermined, the deposition rate A can also be influenced via the joining current I_{Fa}, I_{Fb}, since a variation of the joining current I_{Fa}, I_{Fb} results, due to this dependency, in a variation of the wire feed speed v_{Da}, v_{Db}. Typically, the joining current I_{Fa}, I_{Fb} increases with a known ratio with increasing wire feed speed v_{Da}, v_{Db}. Since the joining current I_{Fa}, I_{Fb} is naturally determined by the joining voltage applied to the joining wire 5a, 5b, the deposition rate A can also be influenced by the joining voltage.

Consequently, the joining current I_{Fa}, I_{Fb}, the wire feed speed v_{Da}, v_{Db} and the joining voltage are possible joining parameters that influence the deposition rate A of the arc joining process.

In an arc joining process, the joining current I_{Fa}, I_{Fb} and the wire feed speed v_{Da}, v_{Db} are usually connected to one another via a predetermined characteristic curve that defines the dependency. The variation of the joining current I_{Fa}, I_{Fb} thus usually also leads to a variation in the wire feed speed v_{Da}, v_{Db}, and vice versa.

This is explained in FIG. 6 using the exemplary embodiment of a multiple arc joining method with two pulsed arc joining processes (as described in FIG. 2).

The upper graph in FIG. 6 shows the time curve of the joining currents I_{Fa}, I_{Fb} of the two pulsed arc joining processes, the middle graph shows the time curve of the wire feed speeds v_{Da}, v_{Db} of the two pulsed arc joining processes, and the lower graph shows the variation functions vₐ(fᵥ), v_{b}(fᵥ) used. In this embodiment, the pulse frequencies f_{Da}, f_{Db} of the pulsed arc joining processes are approximately 30 times the variation frequency fᵥ of the variation functions vₐ(fᵥ), v_{b}(fᵥ). In this exemplary embodiment, the variation functions vₐ(fᵥ), v_{b}(fᵥ) are normalized to one and are trapezoidal, and the amplitude of the variation functions vₐ(fᵥ), v_{b}(fᵥ) varies between 0.25 and 1. The wire feed speeds v_{Da}, v_{Db} of the two pulsed joining processes are superimposed by the respective variation function vₐ(fᵥ), v_{b}(fᵥ), so that the wire feed speeds v_{Da}, v_{Db} are varied with the variation frequency fᵥ=1/tᵥ according to the amplitude of the variation functions vₐ(fᵥ), v_{b}(fᵥ), and specifically between v_{Da}, v_{Db} and 0.25·v_{Da}, 0.25·v_{Db}. In this exemplary embodiment, the wire feed speeds v_{Da}, v_{Db} are consequently cyclically reduced from the predetermined value to a quarter of the predetermined value. Since the joining currents I_{Fa}, I_{Fb} are dependent on the wire feed speeds v_{Da}, v_{Db}, consequently the currents I_{Fa}, I_{Fb} are also influenced and in this exemplary embodiment cyclically reduced according to the predetermined dependency between wire feed speed and joining current. In this way, the deposition rate A of the pulsed arc joining processes is cyclically varied with the variation frequency fᵥ, resulting in the desired fish scale seam pattern.

Alternatively, the variation functions vₐ(fᵥ), v_{b}(fᵥ) could also be predetermined directly as values for the wire feed speed v_{Da}, v_{Db} and/or the joining currents I_{Fa}, I_{Fb}, for example as values of the wire feed speed v_{Da}, v_{Db} between 6 m/min and 12 m/min. In this context, “vary” means that the predetermined values for the wire feed speed v_{Da}, v_{Db} and/or the joining currents I_{Fa}, I_{Fb} are replaced by the values of the variation functions vₐ(fᵥ), v_{b}(fᵥ).

In FIG. 6, it is also shown that in this exemplary embodiment the cycle frequencies f_{Da}, f_{Db} of the arc joining processes are also dependent on the wire feed speeds v_{Da}, v_{Db}. In this example, the cycle frequencies f_{Da}, f_{Db} of the arc joining processes are also lowered with decreasing wire feed speeds v_{Da}, v_{Db}. However, in this case the cycle frequencies f_{Da}, f_{Db} of the arc joining processes still remain significantly higher than the variation frequency fᵥ of the variation functions vₐ(fᵥ), v_{b}(fᵥ).

In the exemplary embodiment shown in FIG. 6, the variation functions vₐ(fᵥ), v_{b}(fᵥ) are temporally synchronized with each other, with a phase shift t_{pV} of 0°. However, a phase shift >0° (but max.) 180° could also be provided, as shown in FIG. 7. For the sake of simplicity, only the variation functions vₐ(fᵥ), v_{b}(fᵥ) and the wire feed speeds v_{Da}, v_{Db} are shown in FIG. 7.

The temporal synchronization of the variation functions vₐ(fᵥ), v_{b}(fᵥ) of the arc joining processes involved in the multiple arc joining method can be effected in the same way as the synchronization of the joining processes themselves. For the synchronization of the variation functions vₐ(fᵥ), v_{b}(fᵥ), the joining devices 1a, 1b exchange synchronization information SV, either once or repeatedly. For this purpose, a communication connection 14 can be provided between the joining devices 1a, 1b involved, preferably between the control units 7a, 7b of the joining devices 1a, 1b, as shown in FIG. 1. The communication connection 14 can be wired or wireless.

In the simplest case, the communication connection 14 is an electrical line on which an electrical current pulse and/or voltage pulse is transmitted as synchronization information SV from a transmitting joining device 1a, 1b to a receiving joining device 1a, 1b. However, a specific signal pattern or a signal frequency, or any other information that can be transmitted via the communication connection 14, can also be used as synchronization information SV.

The communication connection 14 can also be designed as a data bus. In this case, a data communication protocol is implemented on the data bus, and the synchronization information SV is transmitted according to the data communication protocol from a transmitting joining device 1a, 1b to a receiving joining device 1a, 1b, for example in a bus message of the data communication protocol. Which joining device 1a, 1b is the transmitting device and which is the receiving device can be predetermined. In the case of more than two joining devices 1a, 1b, however, usually only one is the transmitting joining device 1a, 1b and the others are the receiving joining devices.

In a multiple arc joining method with synchronized arc joining processes, the variation functions vₐ(fᵥ), v_{b}(fᵥ) of the arc joining processes involved are thus additionally also synchronized. An optional synchronization of the arc joining processes and a synchronization of the variation functions vₐ(fᵥ), v_{b}(fᵥ) can be done independently of each other. The variation functions vₐ(fᵥ), v_{b}(fᵥ) could, however, also be temporally synchronized with the arc joining processes.

How the variation of wire feed speeds v_{Da}, v_{Db} or the joining currents I_{Fa}, I_{Fb} or the joining currents I_{Fa}, I_{Fb} or the joining voltages, or another joining parameter of an arc joining process that (also indirectly) influences the deposition rate A (for example a cycle frequency f_{Da}, f_{Db}), is implemented by the variation functions vₐ(fᵥ), v_{b}(fᵥ), is not relevant to the invention. There are various possible design variants for varying a joining parameter that influences the deposition rate A.

A joining parameter that influences the deposition rate A (also indirectly) is in particular the wire feed speed v_{Da}, v_{Db}, a joining current I_{Fa}, I_{Fb}, a joining voltage, or a cycle frequency f_{Da}, f_{Db}.

For example, the joining parameter to be influenced could be multiplied by the associated variation function vₐ(fᵥ), v_{b}(fᵥ) at each point in time considered. This is particularly useful for variation functions vₐ(fᵥ), v_{b}(fᵥ) normalized to one, or for variation functions vₐ(fᵥ), v_{b}(v) which are expressed as a percentage. In this way, the required values of the joining parameters are obtained at each point in time.

However, it is conceivable to store the values of the joining parameters required for the implementation of the arc joining processes in tabular form, in the joining devices 1a, 1b for a multiple arc joining method. This is particularly useful when the variation functions vₐ(fᵥ), v_{b}(fᵥ) predetermines values for the joining parameters.

Such a table can be constructed for a pulsed arc joining process as shown in FIG. 2, as shown in Table 1 below.

TABLE 1

| | | | | | |
|---|---|---|---|---|---|
| v_{D} | f_{D} | I_{FI} | I_{FG} | Tₚ | . . . |

| | | | | |
|---|---|---|---|---|
| V_{Dmin} | f_{Dmin} | I_{FImin} | I_{FGmin} | T_{Pminx} |
| e.g. 2 m/min | e.g. 15 Hz | e.g. 425 A | e.g. 15 A | e.g. 1.5 ms |
| . . . | . . . | . . . | . . . | . . . |
| V_{Dmax} | f_{Dmax} | I_{FImax} | I_{FGmax} | T_{Pmax} |
| e.g. 20 m/min | e.g. 400 Hz | e.g. 550 A | e.g. 175 A | e.g. 2 ms |

The variation frequency fᵥ and the number of rows in the table then determines at what time interval new values of the joining parameters, in this example the wire feed speed v_{D}, the cycle frequency f_{D}, the joining current I_{F} (here in the form of the base current I_{FG}, and the pulse current I_{FI}), the pulse duration Tₚ of a current pulse and possibly other joining parameters, are taken from the table and used to control the arc joining process. Interpolation or extrapolation can be performed between values in the table as required.

It is thus also possible to store different tables for different arc joining processes. When implementing an arc joining process, all that remains is then to select the correct table.

The values in the table can be determined in advance, for example by testing multiple arc joining methods with the joining devices 1a, 1b. This can be done, for example, by the manufacturer of the joining devices 1a, 1b and stored in the joining devices 1a, 1b.

However, such a table can also be made dependent on other parameters, for example on a joining speed, which indicates, for example, how quickly the electrode holders 4a, 4b are moved. The joining speed can of course influence joining parameters, such that there can be different tables with joining parameters for different joining speeds. Depending on the current joining speed, the required joining parameters can then be taken from the assigned table.

The procedure according to the invention is explained again with reference to FIG. 8, using the example of a joining arrangement 15 for carrying out a multiple arc joining method, in the exemplary embodiment shown with two arc joining methods, each of which implements an arc joining process with a joining device 1a, 1b. The joining devices 1a, 1b are shown only as far as necessary. Each arc joining process is controlled by the associated control unit 7a, 7b through predetermined time curves of joining parameters FPa, FPb. In this exemplary embodiment, the time curves of the joining parameters FPa, FPb are read from a memory unit 18a, 18b of the associated joining device 1a, 1b, although these time curves can also originate from other sources. The joining parameters FPa, FPb include at least the joining currents I_{Fa}, I_{Fb} and the wire feed speeds v_{Da}, v_{Db}. These joining parameters FPa, FPb are dependent on each other in a predefined manner, so that a change in one of these joining parameters FPa, FPb results in a change in the other joining parameter FPa, FPb. For each arc joining process, a periodic variation function vₐ(fᵥ), v_{b}(fᵥ) is also predetermined, for example stored in the associated memory unit 18a, 18b, as in the embodiment of FIG. 8. In each arc joining process, at least one of the joining parameters FPa, FPb belonging to the respective arc joining process, which parameter influences a deposition rate A of the arc joining process that is dependent on the wire feed speed v_{Da}, v_{Db} and the joining wire 5a, 5b, is varied with the associated periodic variation function vₐ(fᵥ), v_{b}(fᵥ) with a variation frequency fᵥ. This variation can be made in the respective control unit 7a, 7b. As a result of this variation, the predefined time curve of the wire feed speed v_{Da}, v_{Db} and thus, due to the predetermined dependency, also the predetermined time curve of the joining current I_{Fa}, I_{Fb} is influenced. This influence occurs periodically depending on the variation function vₐ(fᵥ), v_{b}(fᵥ). The arc joining processes are carried out with these varied time courses of the wire feed speed v_{Da}, v_{Db} and of the joining current I_{Fa}, I_{Fb}. I.e., for example, that the current sources 2a, 2b are controlled to determine the time curves of the joining currents I_{Fa}, I_{Fb}, and if necessary also other joining parameters FPa, FPb, and the wire feed units 3a, 3b are controlled to produce the time curve of the wire feed speeds v_{Da}, v_{Db}.

Through the periodic variation with the variation functions vₐ(fᵥ), v_{b}(fᵥ) the actual time curves of the joining current I_{Fa}, I_{Fb} predetermined by the implemented arc joining processes, and the wire feed speed v_{Da}, v_{Db}, are changed. This means that joining takes place at least sometimes with joining parameters FPa, FPb different from those provided for by the arc joining processes.

In FIG. 8 it is also evident that the variation functions vₐ(fᵥ), v_{b}(fᵥ) can be temporally synchronized with each other. For this purpose, the control units 7a, 7b can also exchange synchronization information SV, as described above.

1. A multiple arc joining method, with which a plurality of arc joining processes are carried out simultaneously, to produce a joining seam on a workpiece, wherein, during the execution of the multiple arc joining method for implementing each of the arc joining processes involved, an arc at least temporarily burns between a joining electrode and the workpiece and an electrical joining current at least temporarily flows over the joining electrode and a joining wire is moved towards the arc at a wire feed speed, wherein each of the arc joining processes involved is carried out with a predetermined time curve of joining parameters and the time curve of the joining parameters comprises at least a predetermined time curve of the joining current and a predetermined time curve of the wire feed speed, which are interdependent, wherein in each arc joining process, at least one joining parameter, influencing a deposition rate of the arc joining process, the deposition rate depending on the wire feed speed and the joining wire, is varied by a periodic variation function with a variation frequency, wherein the variation frequency is the same in each variation function, so that as a result of this variation, in each arc joining process, the predetermined time curve of the wire feed speed and the predetermined time curve of the joining current are periodically varied according to the variation function.

2. The multiple arc joining method according to claim 1, wherein each arc joining process involved is performed with predetermined joining cycles cyclically repeated with a cycle frequency, and the lowest cycle frequency of an arc joining process is 2 to 50 times the variation frequency.

3. The multiple arc joining method according to either claim 1, wherein the variation functions of the arc joining processes are synchronized in terms of time.

4. The multiple arc joining method according to claim 3, wherein variation functions are synchronized to each other with a phase shift between 0° and 180°.

5. The multiple arc joining method according to claim 1, wherein the majority of the arc joining processes are synchronized in terms of time.

6. The multiple arc joining method according to claim 5, wherein the majority of the arc joining processes are synchronized with a phase shift between 0° and 180°.

7. A joining arrangement for carrying out a multiple arc joining method with a plurality of joining devices, which are each configured to carry out an arc joining process to produce a joining seam on a workpiece when using the joining arrangement, wherein each joining device comprises a power source, a wire feed unit, a control unit and a joining electrode, and each joining device being configured, during execution of the multiple arc joining method for implementing one of the participating arc joining processes, to generate a joining current, flowing via the joining electrode, with the power source, so that at least temporarily an arc burns between the joining electrode and the workpiece, and to move a joining wire to the arc with a wire feed speed using the wire feed unit, and to control the power source and the wire feed unit with the control unit to carry out each of the arc joining processes involved with a predetermined time curve of joining parameters, wherein the time curve of the joining parameters comprises at least a predetermined time curve of the joining current and a predetermined time curve of the wire feed speed, which are interdependent, wherein each joining device, for implementing the associated arc joining process, is configured to vary at least one joining parameter in the associated arc joining process with a periodic variation function with a variation frequency using the control unit, the at least one joining parameter influencing a deposition rate of the arc joining process, which deposition rate depends on the wire feed speed and the joining wire, wherein the variation frequency is the same in each variation function, to periodically vary the predetermined time curve of the wire feed speed and the predetermined time curve of the joining current, in each arc joining process, depending on the variation function.

8. The joining arrangement according to claim 7, wherein each joining device, for implementing the associated arc joining process, is configured to carry out the associated arc joining process with predetermined joining cycles repeated cyclically with a cycle frequency using the control unit, wherein the lowest cycle frequency of the arc joining processes involved in the multiple arc joining method is 2 to 50 times the variation frequency (fᵥ).

9. The joining arrangement according to claim 7, wherein the control units of the joining devices involved for implementation of the multiple arc joining method are configured to temporally synchronize the variation functions of the arc joining processes to each other.

10. The joining arrangement according to claim 9, wherein the control units of the joining devices are connected to one another via a communication connection and the control units are configured to transmit synchronization information via the communication connection, for synchronizing the variation functions.

11. The joining arrangement according to claim 7, wherein the control units of the joining devices involved in implementing the multiple arc joining method are configured to temporally synchronize the majority of the arc joining processes with one another.
